(19) United States
(12) Patent Application Publication
(10) Pub. No.: US 2012/0133883 A1
(43) Pub. Date: May 31, 2012

(54) Replaceable decorative panel system for eyeglass frame

(76) Inventor: Michele Marie Mezher, Fairfax, VA (US)

(21) Appl. No.: 12/927,897

(22) Filed: Nov. 30, 2010

(51) Int. Cl. G02C 11/02

(52) U.S. Cl. 351/52

(57) ABSTRACT

A replaceable decorative panel system for eyeglass frames with temple pieces constructed wholly or partly of ferrous metal, a left magnetic strip, a right magnetic strip, a left decorative panel and a right decorative panel. The decorative panels each have a recessed portion on their inside walls. The magnetic strips are each attached into the recessed portion of each the decorative panel. The left and right temple pieces each have an outwardly protruding portion sized to fit within the recessed portion of each decorative panel. The temple pieces have the same top to bottom dimension as those of the decorative panels. The protruding portion makes contact with the magnetic strip causing the decorative panel to be removably fastened to the temple piece so that the top and bottom edges of the decorative panel remain in alignment with the top and bottom edges of the temple piece.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of eyeglass frame construction and more specifically to replaceable decorative panel system for the temple portions of an eyeglass frame.

Eyeglasses have been in use for hundreds of years. Many styles of glasses have been designed during that time. Some of these eyeglasses have temple pieces that include decorated elements of colored or patterned strips or even inset gem stones. However, there is a deficiency in the prior technology in that the decorative portion of the left and right temple pieces are permanently attached to the outside surfaces of the temple pieces. If a person wishes to wear glasses whose temple pieces have a different color scheme or pattern, they must purchase additional pairs of glasses. This solution is costly and may be impossible if the eyeglass temple pieces of the additional glasses are not manufactured in the desired color or style.

### BRIEF SUMMARY OF THE INVENTION

The primary object of the invention is to provide a way to remove and replace a decorative panel located on the outside surface of the temple portion of an eyeglass frame.

Other objects and advantages of the present invention will become apparent from the following descriptions, taken in connection with the accompanying drawings, wherein, by way of illustration and example, an embodiment of the present invention is disclosed.

In accordance with a first embodiment of the invention, there is disclosed a replaceable decorative panel system for an eyeglass frame comprising: a left and right temple piece constructed wholly or partly of metal containing ferrous material, a left magnetic strip, a right magnetic strip, a left decorative panel, a right decorative panel, said decorative panels each having a recessed portion on their inside walls, said left and right magnetic strips each fixedly attached into the said recessed portion of said inside wall of each said decorative panel, said left and right temple pieces each having an outwardly directed thickened portion sized to fit within said recessed portion of said decorative panel, said left and right temple pieces having the same width as the outside dimensional width of said decorative panel, and said thickened portion capable making contact with said magnetic strip causing said decorative panel to be removably fastened to said temple piece in a manner that causes the top and bottom edges of said decorative panels to be in alignment with the top and bottom edges of said temple pieces.

In accordance with a second embodiment of the invention, there is disclosed replaceable decorative panel system for eyeglass frame comprising: a left and right temple piece constructed wholly or partly of metal containing ferrous material, a left magnetic strip, a right magnetic strip, a left decorative panel, a right decorative panel, said temple pieces each having a recessed portion on their outward facing surface, said remaining non-recessed portions of each said temple piece forming a frame on said outward facing surface, said left and right magnetic strips each fixedly attached into the inside wall of each said decorative panel, said magnetic strips each capable of making contact with the metallic surface of the wall of each said recessed portion of said temple pieces so that said decorative panels remain removably attached within the said frame portions of said temple pieces.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the first embodiment of the invention.

FIG. 2 is an exploded view of the first embodiment of the invention.

FIG. 3 is a cross section view of the temple piece of the first embodiment of the invention.

FIG. 4 is a perspective view of the second embodiment of the invention.

FIG. 5 is an exploded view of the second embodiment of the invention.

FIG. 6 is a cross section view of the temple piece of the second embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

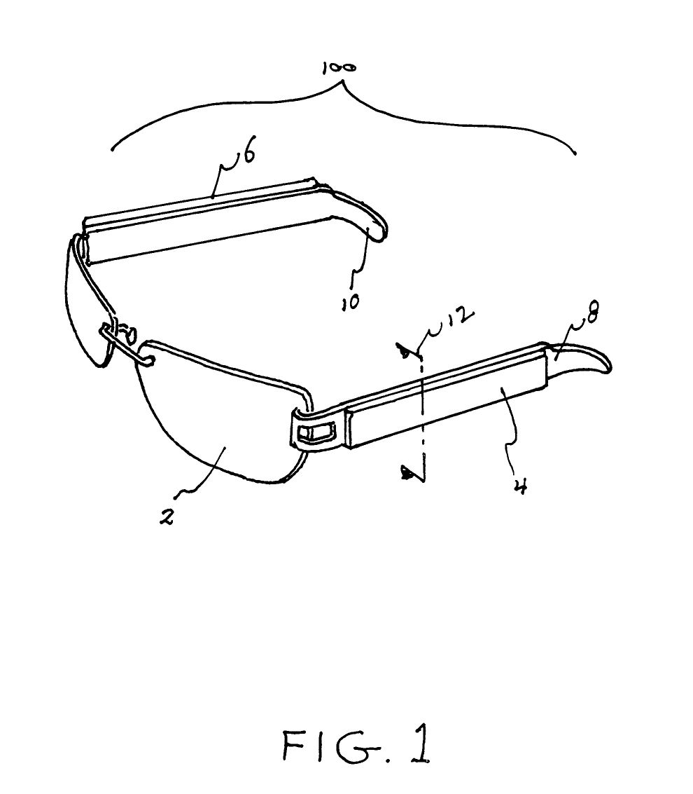

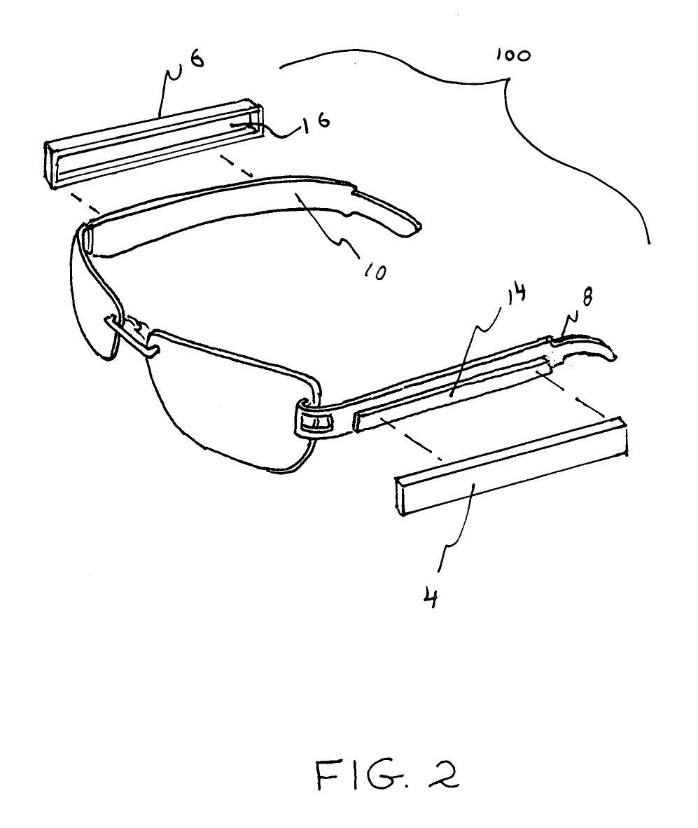

Referring now to FIG. 1 we see a perspective view of a first embodiment of the invention 100. The left and right temples 8, 10 of the glasses 2 include side panels 4, 6 that are attached to the temples 8, 10 by magnetic force. This allows the side panels 4, 6 to be removed and replaced according to the user's desire to change colors or patterns of the eyeglasses. In the first embodiment 100, the panels 4, 6 have a recessed portion on their interior wall as shown in the exploded view in FIG. 2. The temples 8, 10 include a protrusion 14 that is shaped to fit snuggly into the recessed portion. The temple pieces are wholly or partly made of metal containing ferrous material so that a magnetic strip 16 attached to each inside wall of the panels 4, 6 can removably retain the side panels 4, 6. The construction is such that the top and bottom edges of the side panels 4, 6 match the top and bottom edges of each temple piece 8, 10. Alternately, individual small magnets can be used in place of the magnetic strip material 16 shown in the preferred embodiments.

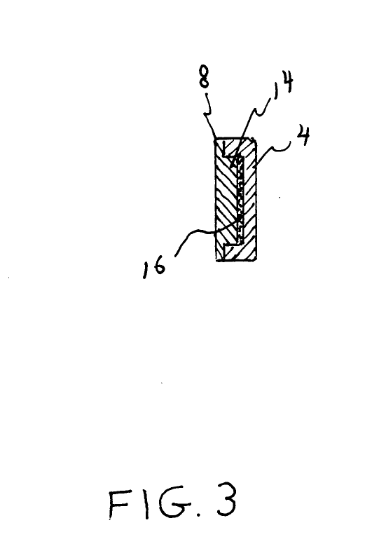

FIG. 3 shows a side section of the temple assembly as defined by section line 12 in FIG. 1. Temple piece 8 includes protrusion portion 14 which slips snuggly into the recess of removable side panel 4 until it makes contact with magnetic strip 16 which is fixedly attached to the inside of the recessed portion of the side panel 4. The side panels can be made of a variety of materials including metal, wood or plastic and can have printed patterns or color applications in a wide variety of designs.

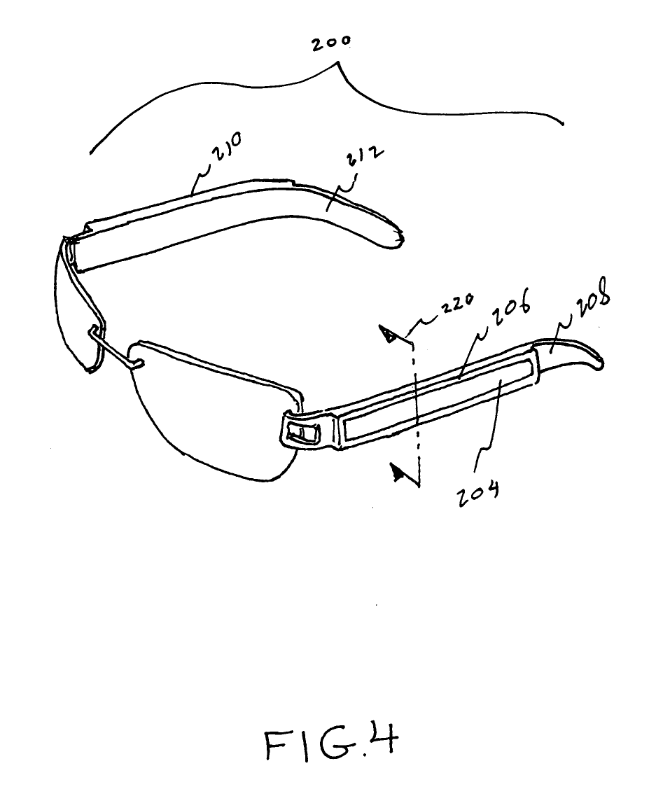

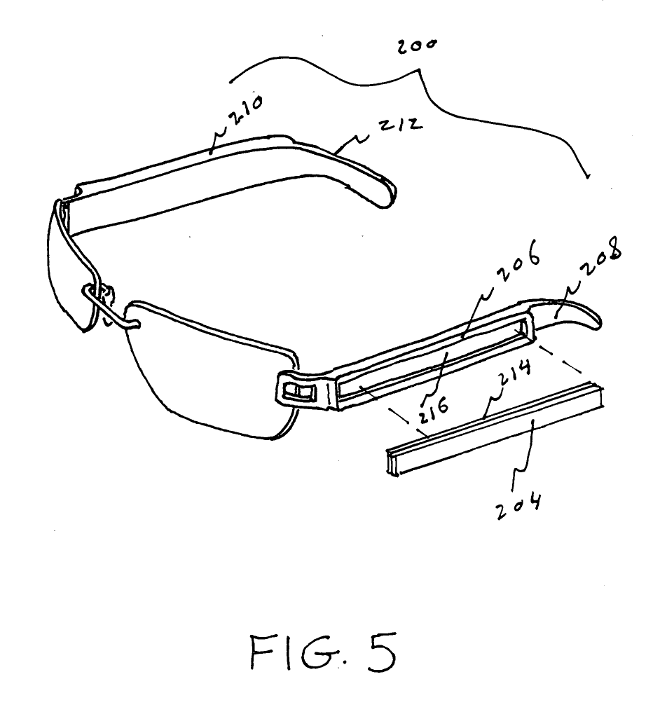

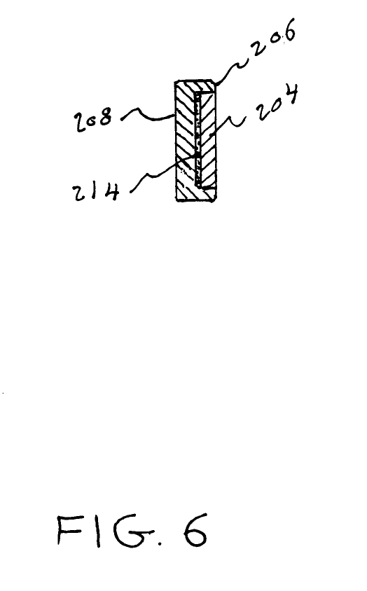

FIG. 4 shows a perspective view of a second embodiment of the invention 200. In this embodiment the left and right temple portions 208, 212 include a recess that forms a frame portion 206, 210 which can receive a decorative side panel 204. The temples are constructed wholly or partly of metallic material having wholly or partly ferrous metal content. The side panels 204, as shown in FIG. 5, include a magnetic strip 214 fixedly attached to the inside wall of the side panel 204. The side panel 204 fits snuggly into the recess 216 of the temple 208. The same design can be found on temple piece 212. FIG. 6 shows a section view of the temple assembly as defined by section line 220 in FIG. 4. Temple 208 includes a frame portion 206 that can removably retain side panel 204. Magnetic strip 214 is fixedly attached to the inside wall of the side panel 204. The magnetic strip is attracted to the ferrous metallic inside wall of the temple piece 208. The resulting effect is similar to the first embodiment except that a frame portion 206 captures the side panel 204 preventing it from moving up or down with respect to the temple piece 208.

It should be noted that the shape of the temple pieces and the side panels can be something other than rectilinear, such as a truncated triangle shape, a curved shape or an irregular shape. Additionally, a plurality of small magnets may be used in place of one magnetic strip.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. replaceable decorative panel system for eyeglass frame comprising:
a left and right temple piece constructed wholly or partly of metal containing ferrous material;
a left magnetic strip;
a right magnetic strip;
a left decorative panel;
a right decorative panel;
said decorative panels each having a recessed portion on their inside walls;
said left and right magnetic strips each fixedly attached into the said recessed portion of said inside wall of each said decorative panel;
said left and right temple pieces each having an outwardly directed thickened portion sized to fit within said recessed portion of said decorative panel and
said thickened portion capable making contact with said magnetic strip causing said decorative panel to be removably fastened to said temple piece in a manner that causes said top and bottom edges of said decorative panel to be in alignment with the top and bottom edges of said temple piece.

2. A replaceable decorative panel system for eyeglass frame constructed in an alternate embodiment comprising:
a left and right temple piece constructed wholly or partly of metal containing ferrous material;
a left magnetic strip;
a right magnetic strip;
a left decorative panel;
a right decorative panel;
said temple pieces each having a recessed portion on their outward facing surface;
said remaining non-recessed portions of each said temple pieces forming a frame on said outward facing surface;
said left and right magnetic strips each fixedly attached into the inside wall of each said decorative panel;
said magnetic strips each capable of making contact with said metallic surface of the inside wall of each said recessed portion of each said temple piece so that said decorative panels remain removably attached within the said frame portions of said temple pieces.
